(19) United States
(12) Patent Application Publication
(10) Pub. No.: US 2003/0076413 A1
(43) Pub. Date: Apr. 24, 2003

(54) System and method for obtaining video of multiple moving fixation points within a dynamic scene

(76) Inventors: Takeo Kanade, Pittsburgh, PA (US); Omead Amidi, Pittsburgh, PA (US); Robert Collins, Pittsburgh, PA (US)

Correspondence Address: KIRKPATRICK & LOCKHART LLP, 535 SMITHFIELD STREET, PITTSBURGH, PA, 15222, US

(21) Appl. No.: 10/032,648

(22) Filed: Oct. 23, 2001

(51) Int. Cl. H04N 7/18; H04N 9/47

(52) U.S. Cl. 348/139; 348/159

(57) ABSTRACT

A system and method for obtaining video of a moving fixation point within a scene. According to one embodiment, the system includes a control unit and a plurality of non-moving image capturing devices positioned around the scene, wherein the scene is within a field of view of each image capturing device. The system also includes a plurality of image generators, wherein each image generator is in communication with one of the image capturing devices, and wherein a first of the image generators is responsive to a command from the control unit. The system also includes a surround-view image sequence generator in communication with each of the image generators and responsive to the command from the control unit for generating a surround-view video sequence of the fixation point within the scene based on output from certain of the image generators.

### BACKGROUND OF INVENTION

1. Field of Invention

The present invention relates generally to image processing and, more particularly, to systems and methods for obtaining video of multiple moving fixation points within a dynamic scene.

2. Description of the Background

In video applications, it is often desirable to separately take a set of images of a spot of action, called a fixation point, with a number of cameras surrounding the fixation point. From these sets of images one can create a so-called “3D surround-view” image sequence, which will make viewers feel as if they are flying around the scenes they see. Such image sequences are also sometimes referred to as a “3D fly-around” image sequence and “spin-image” sequence. This type of display heightens the viewer's ability to perceive the 3D spatial relationships between objects in the scene.

Initial systems to produce the “3D surround-view” effect were composed of several stationary cameras pointed at a single fixation point in the scene. The most well known examples are from the motion picture “The Matrix,” although several broadcast commercials have also used this technique. The drawback to this approach is that the action has to occur at a single fixation point in the scene.

Later systems for generating such effects captured the images using cameras mounted on robotic pan/tilt devices. Using a servo loop, the pan/tilt devices allow the camera to follow a moving fixation point in real-time throughout the scene. The drawback to this approach is that the system still can only fixate on one point at a time. Moreover, it is difficult to adequately compensate for the servo errors that are introduced with such a system.

Accordingly, there exists a need for a manner in which to take a video set of multiple fixation points in a dynamic scene simultaneously, such that separate 3D surround-view image sequences of those fixation points may be obtained simultaneously.

### BRIEF SUMMARY OF THE INVENTION

The present invention is directed to a system and method for obtaining video of multiple moving fixation points within a dynamic scene. According to one embodiment, the system includes a plurality of non-moving image capturing devices oriented around the scene such that the entire scene is substantially within the field of view of each image capturing device. The image capturing devices may be, for example, camera banks, each having a number of non-moving cameras, panoramic wide field of view cameras, or a combination thereof. Output from the image capturing devices is input to a number of image generators, one for each image capturing device. The image generators are capable, given a viewing angle and zoom parameter, of computing an image frame that a virtual camera positioned at its associated image capturing device, pointing to the given viewing angle and with the given zoom, would have output.

A first of the image generators is controlled by a control unit, which receives viewing angle and zoom parameter commands, such as from an operator via a user interface. These viewing angle and zoom parameters are communicated to the first image generator. The appropriate viewing angle and zoom parameter commands for the remainder of the image generators are determined by a mapping module based on the viewing angle and zoom commands from the control unit and from data regarding the calibration between the various image capturing devices. The output image frames from certain of the image generators is input to an image sequence module, which outputs these images in sequence in the order of the placement of the image capturing devices around the scene as desired to generate the 3D surround-view image sequence.

The present invention provides numerous advantages in comparison to the relevant prior art. First, the system never misses an action of interest within the dynamic scene. In the previous master-slave pan/tilt-based systems, a human operator is tasked to identify and track a single action of interest, and all the cameras follow that action. Therefore, if (i) an action of true interest is occurring somewhere else within the scene, (ii) the operator's tracking is delayed, or (iii) the pan/tilt devices have servoing errors or delay, then the system will fail to capture video of the action, either totally or partially. In contrast, the system of the present invention favorably permits capturing all of the images in the scene all of the time.

Second, the present invention permits having multiple fixation points simultaneously. Third, the image generators need not track the target mechanically, and as such do not suffer from any control delay, offset, or other errors associated with servoing. Therefore, matching the point of rotation among images, as is described hereinafter, is improved in comparison with previous systems. Fourth, with the present invention the video can be replayed based on time (forward or backward), based on space (clockwise or counter-clockwise), or any combination thereof.

These and other benefits will be apparent from the description to follow.

### BRIEF DESCRIPTION OF THE FIGURES

The present invention is described in conjunction with the following figures, wherein:

FIG. 1 is a block diagram of a system for obtaining video of multiple moving fixation points within a dynamic scene according to one embodiment of the present invention;

FIG. 2 is a diagram of an image capturing device of FIG. 1 according to one embodiment of the present invention;

FIG. 3 is a diagram illustrating the field of views (FOVs) of the cameras of the camera bank of FIG. 2 according to one embodiment of the present invention;

FIG. 4 is a diagram illustrating a situation in which the FOV of a virtual camera for a camera bank is within the FOV of a camera of that camera bank;

FIG. 5 is a diagram illustrating a situation in which the FOV of a virtual camera for a camera bank is within the FOV of two cameras of that camera bank;

FIG. 6 is a diagram of a portion of the system according to another embodiment of the present invention;

FIG. 7 is a diagram of a portion of the system according to another embodiment of the present invention; and

FIG. 8 is a diagram of the system according to another embodiment of the present invention.

### DETAILED DESCRIPTION OF THE PRESENT INVENTION

It is to be understood that the figures and descriptions of the following embodiments have been simplified to illustrate elements that are relevant for a clear understanding of the present invention, while eliminating, for purposes of clarity, other elements. For example, certain operating system details and modules of computer processing devices are not described herein. Those of ordinary skill in the art will recognize, however, that these and other elements may be desirable in a typical telecommunications device. However, because such elements are well known in the art, and because they do not facilitate a better understanding of the present invention, a discussion of such elements is not provided herein.

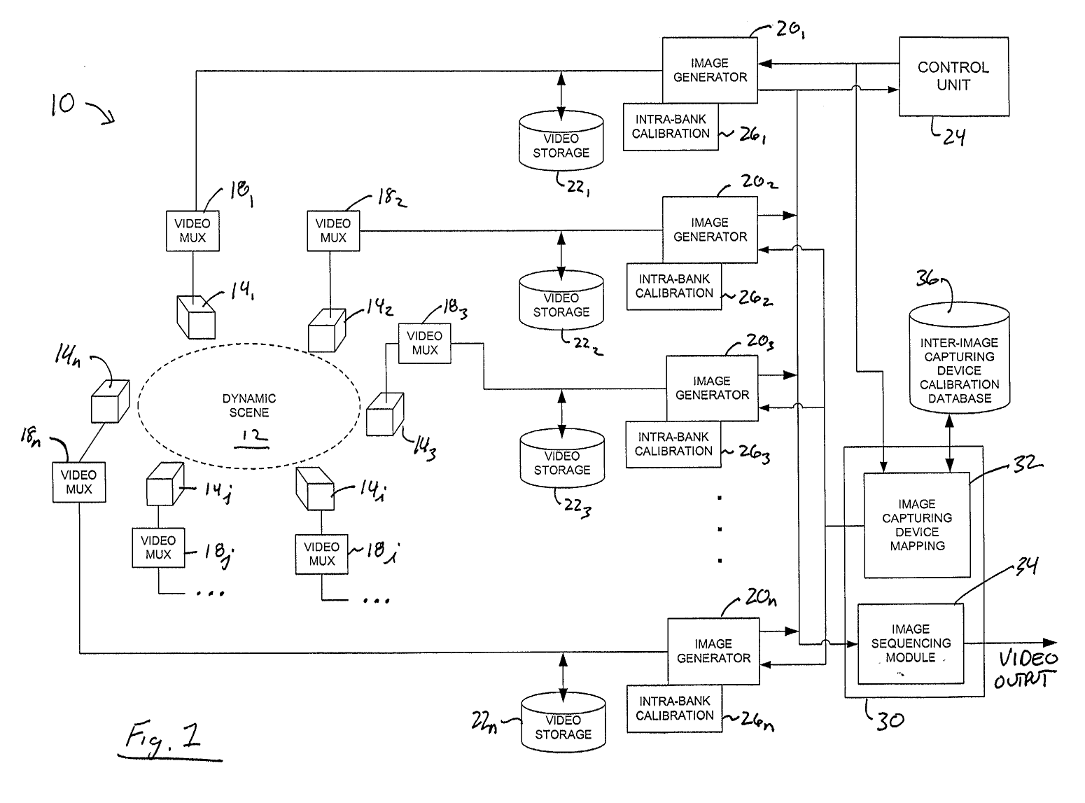

FIG. 1 is a diagram of a system 10 for obtaining video of multiple moving fixation points within a dynamic scene 12 according to one embodiment of the present invention. The system 10 includes a number of static (i.e., non-moving) image capturing devices 14₁₋ₙ surrounding the scene 12. The field of view (FOV) of each of the image capturing devices 14₁₋ₙ may completely or substantially cover the entire scene 12.

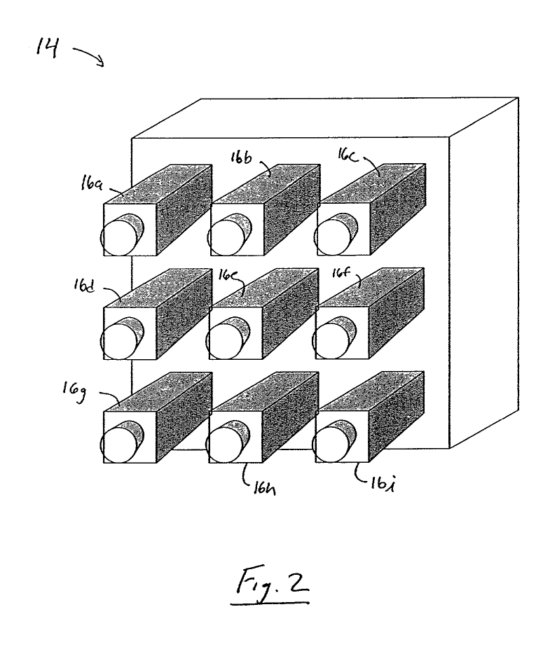

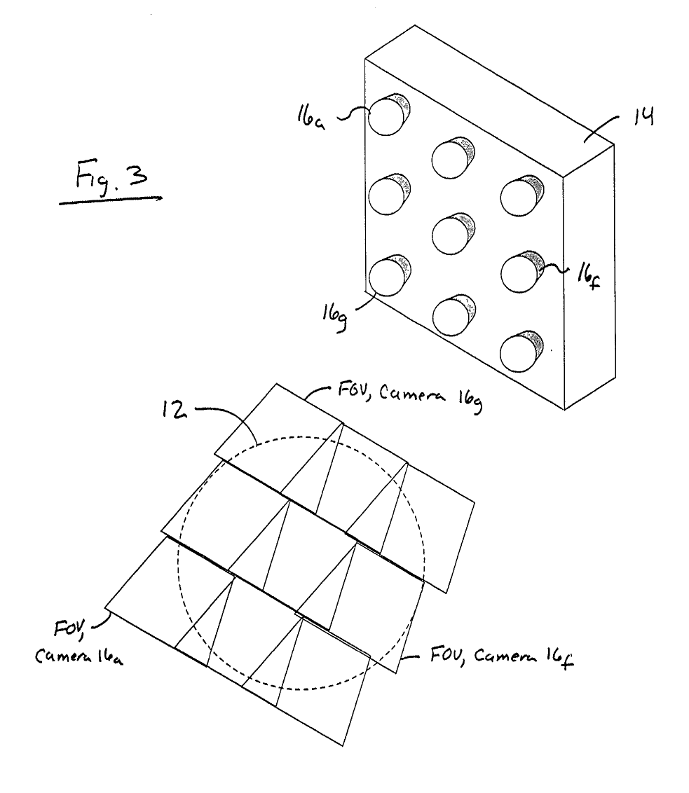

As illustrated in FIG. 2, according to one embodiment, the image capturing devices 14₁₋ₙ may include camera banks, each camera bank 14 including a number of static (i.e., non-moving) cameras 16ₐ₋ᵢ. Each camera 16ₐ₋ᵢ may be fixated on a separate portion of the scene 12, as illustrated in FIG. 3, such that the scene 12 is covered by at least one of the cameras 16ₐ₋ᵢ of each camera bank 14₁₋ₙ. That is, any point in the scene 12 is within the field of view of at least one of the cameras 16ₐ₋ᵢ of each camera bank. In addition, the cameras 16ₐ₋ᵢ on each particular bank may be aligned such that their imaging centers are substantially the same or as close as possible. According to one embodiment, the cameras 16ₐ₋ᵢ are synchronized with a common signal so that the shutter for each camera 16ₐ₋ᵢ fires at precisely the same time, resulting in video frames taken at the same time instant. In addition, the timing of each video frame may be labeled electronically, i.e., time-stamped. Although nine cameras are shown in the camera bank illustrated in FIG. 2, a different number of cameras may be used depending on the application.

According to other embodiments, one, some or all of the image capturing devices 14₁₋ₙ may be, for example, a single camera having a panoramic wide field of view. Such a panoramic wide FOV camera may include, for example, a parabolic or spherical mirror with which a wide angle of view is mapped to the imaging surface of the camera. According to another embodiment, the panoramic wide FOV camera may include, for example, a fish-eye lens with which the wide angle view is captured onto the imaging surface of the camera.

The number of image capturing devices 14 included in the system 10 may depend, for example, on the desired quality of the 3D surround-view image sequence to be generated. For example, the system 10 may include ten to eighty image capturing devices 14 surrounding the scene 12. In addition, according to another embodiment, the image capturing devices 14 may be periodically positioned around the scene 12 such as, for example, every five degrees or every ten degrees.

Returning to FIG. 1, for an embodiment in which the image capturing devices 14 are camera banks such as illustrated in FIG. 2, the system 10 may also include a video multiplexer 18₁₋ₙ coupled to each of the image capturing devices 14₁₋ₙ. The output from each of the cameras 16ₐ₋ᵢ may be multiplexed onto, for example, one video fiber cable by the video multiplexer 18₁₋ₙ that feeds to a separate image generator 20₁₋ₙ and video storage unit 22₁₋ₙ for each image capturing device 14₁₋ₙ. The output video of the cameras 16ₐ₋ᵢ may be digitally stored on a continuous basis in the respective video storage units 22₁₋ₙ, enabling fast retrieval of corresponding frames in time for all cameras. For an embodiment in which the image capturing device 14 is a panoramic wide FOV camera, the video multiplexer coupled between the camera and the image generator may be eliminated.

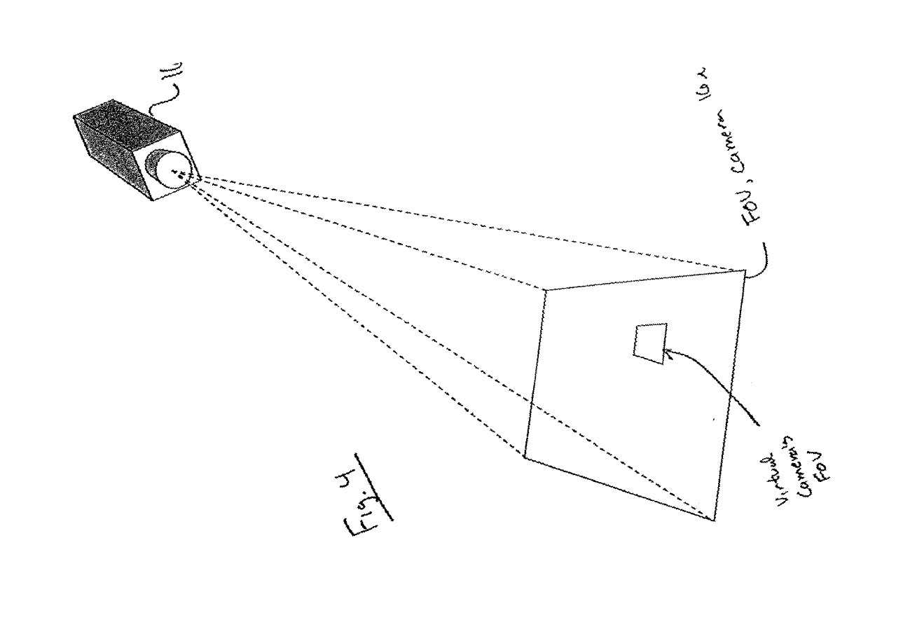

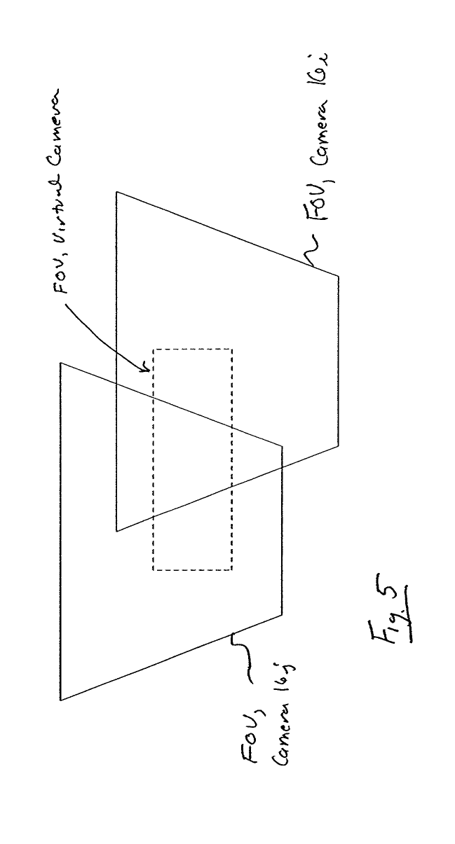

The image generators 20₁₋ₙ may be implemented as computers, such as workstations or personal computers, having software which when executed cause the image generators 20₁₋ₙ to compute an image frame that a virtual camera at its respective image capturing device 14₁₋ₙ would have output, given a particular viewing angle and zoom parameter. The process consists of first backprojecting the image frame of the virtual camera onto the scene 12 to obtain the field of view (FOV) of the virtual camera. Where the image capturing devices 14 include camera banks, if the FOV is completely within the field of view of one of the real cameras 16ₐ₋ᵢ, as illustrated in FIG. 4, then the virtual image may be obtained by cropping the corresponding region from the real image and transforming it perspectively (or simply scaling the image may suffice). If the virtual FOV overlaps across the FOVs of two or more real cameras 16ₐ₋ᵢ, as illustrated in FIG. 5, the virtual image may be obtained by cropping the part images, transforming each of the part images by an appropriate perspective transformation that corresponds to the transformation from the imaging plane of each physical camera 16 to that of the virtual camera, and finally merging the transformed part images into a single frame. The process is known as panoramic mosaicing, and is described generally in H. Shum and R. Szeliski, “Construction of Panoramic Mosaics with Global and Local Alignment,” International Journal of Computer Vision, Vol. 36(2): 101-130, February 2000, which is incorporated herein by reference. To account for the calibration between the cameras 16ₐ₋ᵢ on their particular camera bank 14₁₋ₙ, each image generator 20₁₋ₙ may include an intra-bank calibration database 26₁₋ₙ that contains data regarding the calibration between the cameras 16ₐ₋ᵢ. The intra-bank calibration database can be created by calibrating the intrinsic parameters of each camera and the relative pose between cameras using, for example, well-known camera calibration algorithms used in the fields of computer vision and photogrammetry. For embodiments in which an image capturing device 14 is a panoramic wide FOV camera, the intra-bank calibration database for the corresponding image generator 20₁₋ₙ may be eliminated.

Where an image capturing device 14 is a panoramic wide field of view camera with a mirror, the corresponding image generator 20 may first crop the part of the image corresponding to the space angle of the FOV of the virtual camera and then transform the cropped image to remove the distortion that is contained due to the mirror, parabolic, spherical or otherwise. Where the image capturing device 14 is a camera with a lens, the corresponding image generator 20 may first crop the part of the image corresponding to the space angle of the FOV of the virtual camera and then transform the cropped image to remove distortion that is contained due to the lens, fish-eye or otherwise.

For replay operation, the virtual image generators 20₁₋ₙ may retrieve the video data stored in the video storage units 22₁₋ₙ. For real-time operation, the virtual image generators 20₁₋ₙ may use the real-time video from the image capturing devices 14₁₋ₙ as it is stored in the storage units 22₁₋ₙ.

One of the image generators 20₁₋ₙ may serve as a master virtual camera. For purposes of this discussion, assume the master virtual camera is the image generator 20₁. An operator of a control unit 24 may control the view seen by the master virtual camera based on viewing angle and zoom parameter commands input to the image generator 20₁. The control unit 24 may include an operator interface such as, for example, a pointing device plus a video display. According to one embodiment, the control unit 24 may be similar to a traditional cameraman's tripod, with angle sensors plus zoom and height control knobs. The video seen by the operator on the display monitor would be the video generated by the image generator 20₁. According to another embodiment, the control unit 24 may be a computer terminal where, for example, a mouse or other type of input device is used to input the viewing angle and zoom parameter commands. The control unit 24 interprets the desired pan/tilt angle and zoom from the operator's commands, and inputs them to the image generator 20₁ of the virtual master camera.

As illustrated in FIG. 1, the system 10 also includes a surround-view image sequence generator 30. The surround-view image sequence generator 30 includes an image capturing device mapping module 32 and an image sequencing module 34, and has an associated inter-image capturing device calibration database 36. The generator 30 may be implemented on a computer such as, for example, a workstation or a personal computer. The modules 32, 34 may be implemented as software code to be executed by the generator 30 using any suitable computer language such as, for example, Java, C or C++ using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM. According to one embodiment, the modules 32, 34 may reside on separate physical devices.

The mapping module 32 may receive the viewing angle and zoom parameter commands from the control unit 24 and, based thereon, may compute the three-dimensional location of the action of interest in the scene 12. Using calibration data regarding the calibration between each image capturing device 14₁₋ₙ, which is stored in the inter-image capturing device calibration database 36, the mapping module 32 computes the corresponding viewing angles and zoom data for the virtual cameras of the other image generators 20₂₋ₙ.

The output from certain (all or less than all) of the image generators 20₁₋ₙ is supplied to the image sequencing module 34, which may output these images in sequence in the order of the placement of their image capturing devices 14₁₋ₙ around the scene 12, either clockwise or counter-clockwise, to generate the 3D surround-view image sequence.

As discussed previously, the inter-image capturing device calibration database 36 stores data on the relationship between each image capturing device 14 to the scene 12 and to the other image capturing devices. This data may be determined prior to operation of the system. According to one embodiment, appropriate calibration requires determining the pose (location and orientation) of each of the image capturing devices 14₁₋ₙ with respect to a scene coordinate system. In addition, it includes determining the relationship of the zoom control parameter (from the control unit 24) to angular field of view, and determining the relationship of the focus control parameter (from the control unit 24) to the distance of objects in the scene 12.

Image capturing devices 14 pose may be determined, according to one embodiment, by determining the proper viewing angle of the image generators 20₁₋ₙ for a set of distinguished points or “landmarks” with known 3D coordinates. The viewing angle parameters may be stored with the (x,y,z) coordinates of the landmark to form one pose calibration measurement. According to another embodiment, camera bank pose may be determined by an optimization procedure, using three or more landmark measurements in a nondegenerate configuration.

The mapping module 32 computes the corresponding viewing angles and zoom data for the virtual cameras of the other image generators 20₂₋ₙ based on the viewing angle and zoom parameter commands from the control unit 24. According to one embodiment, this may be performed by first determining the equation of a 3D line specifying the principal viewing ray of the virtual camera of the first image generator 20₁. All points on this line can be represented as p=c+kv, where p is a 3D point on the line, c is the focal point of the virtual master camera of image generator 20₁, and v is a unit vector representing the orientation of the principal axis, directed out from the focal point, and k is a scalar parameter that selects different points on the line. Only points on the line that are in front of the focal point (i.e., k>0) are considered to be on the master camera principal viewing ray.

The desired virtual servo-fixation point (VSFP) for the surround-view effect is defined to be some point on the principal viewing ray of the master virtual camera of the image generator 20₁. Choosing which point is the VSFP is equivalent to choosing a value for parameter k in the above-equation. The VSFP can be determined by intersecting the principal viewing ray with an equation or set of equations representing, for example, a real surface in the scene 12, a virtual (nonphysical) surface in the scene 12, or a combination thereof. If there is more than one intersection point, the desired VSFP should be determined. According to one embodiment, the point closest to the camera bank 14₁ is chosen. In addition, if there is no mathematical intersection point, an alternate method may be used to determine the VSFP. According to one embodiment, the last known valid point of intersection is used.

For each of the other image generators 20₂₋ₙ, the mapping module 32 uses the 3D position of the VSFP to compute the viewing angle value that brings the virtual camera for each of the image generators 20₂₋ₙ principal-viewing ray into alignment with the VSFP. To calculate the zoom parameters for the image generator 20ᵢ, where 2≦i≦n, the distance d between the position of the image capturing device 14ᵢ and the VSFP is computed. If y is the position of the image capturing device 14ᵢ and x is the VSFP, and vector (a,b,c)=x-y, then d may be computed as d=\sqrt{a²+b²+c²}.

The zoom of each of the virtual cameras of image generators 20₁₋ₙ may be controlled to keep the point of interest the same size in all the images, even though the image capturing devices 14₁₋ₙ are different distances away from the object. Let r be the desired radius of a virtual sphere subtending the entire vertical field of view of each image. Let dᵢ be the distance from image capturing device 14ᵢ to the VSFP. Then the desired vertical field of view angle αᵢ can be computed as αᵢ=2·arctan(r/dᵢ). The zoom parameter that achieves this desired field of view is then computed from data collected during the prior zoom calibration procedure.

To control the focus of each of the virtual cameras of the image generators 20₁₋ₙ to achieve sharp focus at the VSFP, the focus parameter that achieves sharp focus at distance dᵢ may be computed for image generator 20ᵢ using the distance vs. focus parameters equations or tables derived from the prior focus camera calibration procedure.

Having computed the proper viewing angle and zoom parameter for each of the image generators 20₂₋ₙ, the mapping module 32 communicates these values to the image generators 20₂₋ₙ. The image generators 20₂₋ₙ then generate the appropriate image frame based on the video frames from the cameras 16ₐ₋ᵢ of their respective camera bank 14₂₋ₙ (or from the image captured by a panoramic wide field of view camera). The images from each of the image generators 20₁₋ₙ is supplied to the image sequencing module 34, which outputs these images in sequence in the order of the placement of their image capturing devices 14₁₋ₙ around the scene 12, either clockwise or counter-clockwise, to generate the 3D surround-view image sequence.

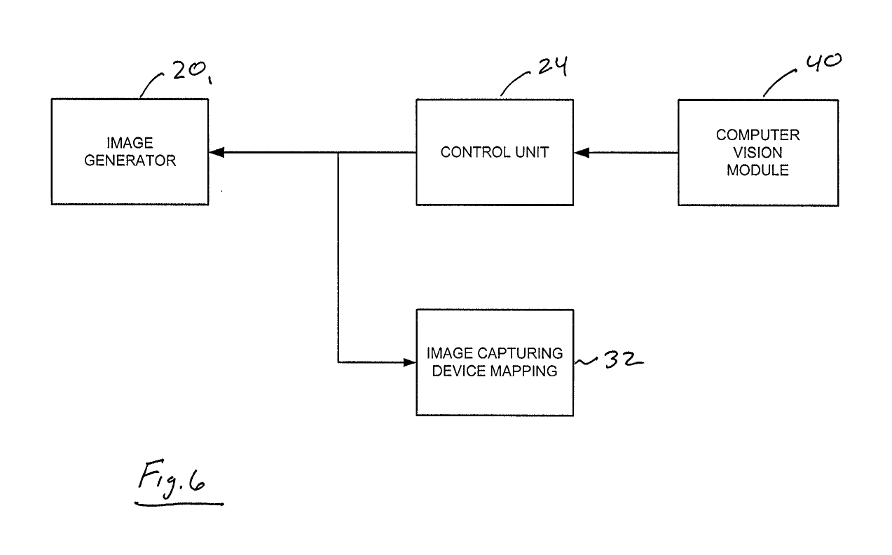

As discussed previously, the control unit 24 outputs viewing angle and zoom commands to the master image generator. In addition, the viewing angle and zoom commands may be generated by a human operator via user interface as discussed previously. According to another embodiment, the human operator may be replaced with a computer vision module 40 as illustrated in FIG. 6. The computer vision module 40 may automatically detect and track moving objects (e.g., fixation points) within the scene 12 by processing video from the master image generator. The computer vision module 40 may be implemented as software code to be executed by a computer processing device, such as a workstation or a personal computer, using any suitable computer language such as, for example, Java, C or C++ using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM. In addition, according to another embodiment, the computer vision module 40 may be able to automatically select a different image generator 20₁₋ₙ as the master image generator to, for example, decrease the distance between the image capturing device 14 corresponding to the master image generator and the object being tracked or to increase the visibility of the object being tracked.

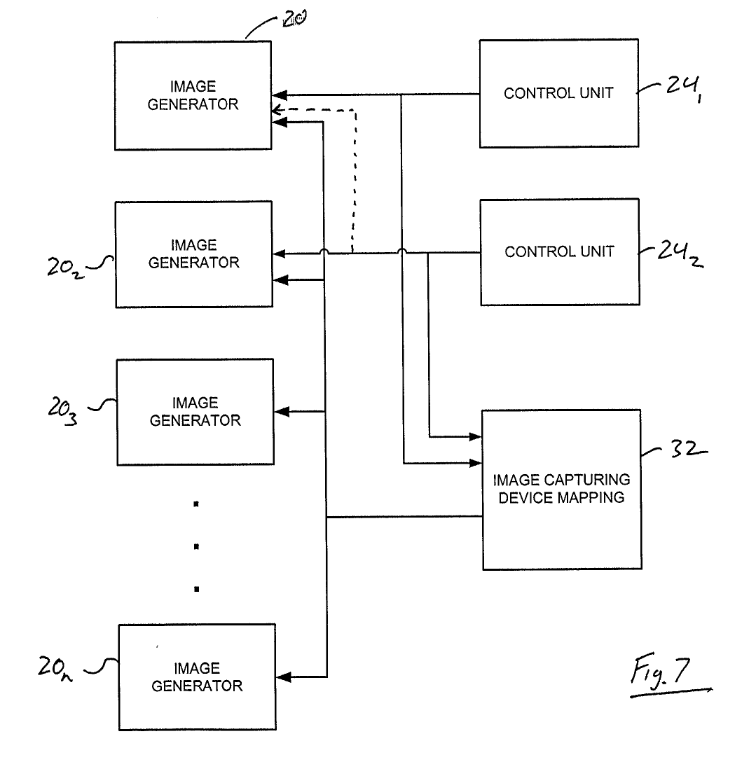

In addition, according to another embodiment of the present invention, multiple master image generators may simultaneously co-exist. According to such an embodiment, multiple and distinct control units 24 may control a master image generator, as illustrated in FIG. 7. As such, individual viewers of the surround-view image sequence may control the fixation point. According to another embodiment, separate control units 24 may control the same image generator 20 as separate master image generators.

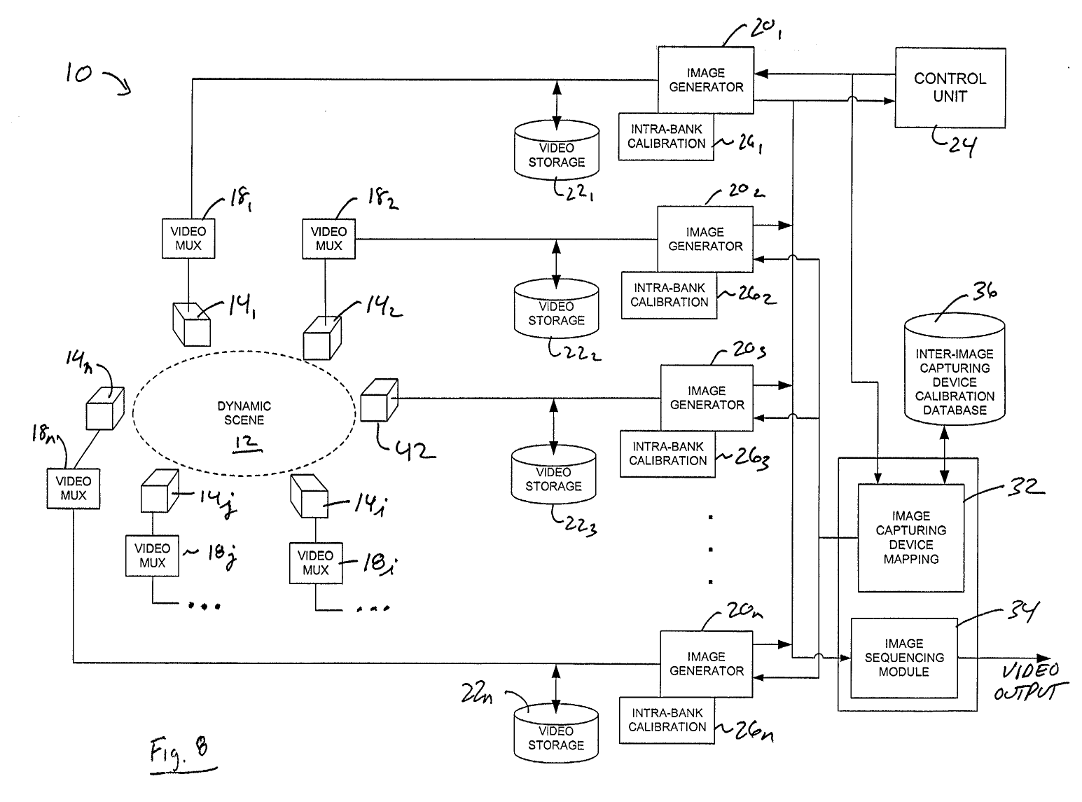

According to other embodiments of the present invention, one or more servo-controlled, moving (e.g., pan/tilt) cameras 42 may be positioned around scene 12, as illustrated in FIG. 8. Each pan/tilt camera 42 may have an image generator 20 associated therewith, as described previously. In a manner similar to that described previously, the pan/tilt cameras 42 may receive the viewing angle and zoom commands based on the output from the control unit 24. The field of view of the pan/tilt cameras 42 need not span the entire scene 12, but may be greater than the field of view necessary to capture images of the fixation point. Thus, the servo errors associated with the pan/tilt cameras 42 may be compensated for by computing the virtual video at their associated image generator 20 that would correspond to the case with no error, thereby realizing smoother transition of view points in the surround-view image sequence. Techniques for computing the virtual video for a pan/tilt camera that corresponds to the case of no servo error are described in provisional U.S. Provisional Patent Applications Serial No. 60/268,205 and Serial No. 60/268,206, both filed on Feb. 12, 2001 and both incorporated herein by reference. Such an embodiment may be advantageous for areas of high interest within the scene 12 because pan/tilt cameras typically have greater resolution than panoramic wide field of view cameras.

Embodiments of the present invention offer important and critical advantages over previous master-slave pan/tilt-based systems. First, one embodiment of the system never misses an action of interest within the dynamic scene 12. In the previous master-slave pan/tilt-based systems, a human operator is tasked to identify and track a single action of interest, and all the cameras follow that action. Therefore, if (i) an action of true interest is occurring somewhere else within the scene 12, (ii) the operator's tracking is delayed, or (iii) the pan/tilt devices have servoing errors or delay, then the system will fail to capture video of the action totally or partially. In contrast, the system of the present invention captures all of the images in the scene 12 all of the time.

Second, one embodiment of the present invention permits having multiple fixation points simultaneously. Third, in one embodiment the so-called slave virtual cameras of image generators 20₂₋ₙ do not track the target mechanically, and as such will not suffer from any control delay, offset, or other errors associated with servoing. Therefore, matching the point of rotation among images, as is described hereinafter, is improved in comparison with previous systems. Fourth, with one embodiment of the present invention the video can be replayed based on time (forward or backward), based on space (clockwise or counter-clockwise), or any combination thereof.

Although embodiments the present invention has been described herein with respect to certain embodiments, those of ordinary skill in the art will recognize that many modifications and variations of the present invention may be implemented. The foregoing description and the following claims are intended to cover all such modifications and variations.

What is claimed is:

1. A system for obtaining video of a moving fixation point within a scene, comprising:
a control unit;
a plurality of non-moving image capturing devices positioned around the scene, wherein the scene is within a field of view of each image capturing device;
a plurality of image generators, wherein each image generator is in communication with one of the image capturing devices, and wherein a first of the image generators is responsive to a command from the control unit; and
a surround-view image sequence generator in communication with each of the image generators and responsive to the command from the control unit for generating a surround-view video sequence of the fixation point based on output from certain of the image generators.

2. The system of claim 1, further comprising an inter-image capturing device calibration database in communication with the surround-view image sequence generator.

3. The system of claim 1, wherein the first image generator is responsive to a viewing angle command and a zoom command from the control unit.

4. The system of claim 1, wherein the surround-view image sequence generator is for generating the surround-view video sequence of the fixation point within the scene by outputting an image from certain of the image generators in sequence according to the position of the image capturing devices around the scene.

5. The system of claim 4, wherein the surround-view image sequence generator includes:
a mapping module for outputting a command to each of the image generators other than the first image generator based on the command from the control unit; and
an image sequencing module in communication with each of the image generators for outputting the image from certain of the image generators in sequence according to the position of the image generators around the scene.

6. The system of claim 4, further comprising an inter-image capturing device calibration database in communication with the mapping module.

7. The system of claim 1, wherein each of the image capturing devices includes a camera bank including a plurality of non-moving cameras.

8. The system of claim 7, wherein at least one of the image generators is in communication with an intra-bank calibration database.

9. The system of claim 1, wherein each of the image capturing devices includes a non-moving panoramic wide field of view camera.

10. The system of claim 1, wherein each of the image capturing devices is selected from the group consisting of a non-moving panoramic wide field of view camera and a camera bank having a plurality of non-moving cameras.

11. The system of claim 1, wherein the image capturing devices are periodically positioned around the scene.

12. The system of claim 1, further comprising:
a moving camera having a field of view within the scene; and
an additional image generator in communication with the moving camera and in communication with the surround-view image sequence generator, wherein the additional image generator is responsive to a second command based on the command from the control unit.

13. The system of claim 12, wherein the moving camera includes a pan/tilt camera.

14. The system of claim 1, further comprising a computer vision module in communication with the control unit.

15. The system of claim 1, wherein the computer vision module is further for selecting a second image generator to be responsive to the command from the control unit.

16. The system of claim 1, further comprising a second control unit, wherein one of the image generators is responsive to a command from the second control unit, and wherein the surround-view image sequence generator is further for generating a second surround-view video sequence of a second fixation point within the scene based on output from certain of the image generators and the command from the second control unit.

17. The system of claim 16, wherein the first image generator is responsive to the command from the second control unit.

18. A system for obtaining video of a moving fixation point within a scene, comprising:
a control unit;
a plurality of non-moving image capturing devices positioned around the scene, wherein the scene is within a field of view of each image capturing device;
a plurality of image generators, wherein each image generator is in communication with one of the image capturing devices, and wherein a first of the image generators is responsive to a viewing angle command and a zoom command from the control unit;
a mapping module for outputting a viewing angle command and a zoom command to each of the image generators other than the first image generator based on the viewing angle command and the zoom command from the control unit; and
an image sequencing module in communication with each of the image generators for outputting an image of the fixation point from certain of the image generators in sequence according to the position of the image generators around the scene.

19. The system of claim 18, further comprising an inter-image capturing device calibration database in communication with the mapping module.

20. The system of claim 19, wherein each of the image capturing devices is selected from the group consisting of a non-moving panoramic wide field of view camera and a camera bank having a plurality of non-moving cameras.

21. The system of claim 20, wherein the image capturing devices are periodically positioned around the scene.

22. The system of claim 20, further comprising a computer vision module in communication with the control unit.

23. The system of claim 18, further comprising a second control unit, and wherein:
one of the image generators is responsive to a viewing angle command and a zoom command from the second control unit;
the mapping module is further for outputting a second viewing angle command and a second zoom command to each of the image generators other than the image generator responsive to the second control unit based on the viewing angle command and the zoom command from the second control unit; and
the image sequencing module is further for outputting an image of a second fixation point within the scene from certain of the image generators in sequence according to the position of the image generators around the scene.

24. The system of claim 23, wherein the first image generator is responsive to the viewing angle command and zoom command from the second control unit.

25. The system of claim 18, further comprising:
a moving camera having a field of view within the scene; and
an additional image generator in communication with the moving camera and in communication with the mapping module and the image sequence generator.

26. The system of claim 25, wherein the moving camera includes a pan/tilt camera.

27. A system for obtaining video of a moving fixation point within a scene, comprising:
a plurality of non-moving image capturing devices positioned around the scene, wherein the scene is within a field of view of each image capturing device;
a plurality of image generators, wherein each image generator is in communication with one of the image capturing devices;
means for controlling a viewing angle and zoom parameter for each of the image generators; and
means for generating a surround-view video sequence of the fixation point based on output from certain of the image generators.

28. The system of claim 27, wherein each of the image capturing devices is selected from the group consisting of a non-moving panoramic wide field of view camera and a camera bank having a plurality of non-moving cameras.

29. The system of claim 27, wherein the image capturing devices are periodically positioned around the scene.

30. The system of claim 27, further comprising means for generating commands for the viewing angle and the zoom parameter.

31. The system of claim 27, further comprising:
a moving camera having a field of view within the scene; and
an additional image generator in communication with the moving camera, wherein the means for controlling the viewing angle and zoom parameter for each of the image generators is further for controlling a viewing angle and zoom parameter for the additional image generator, and wherein the means for generating a surround-view video sequence of the fixation point is further for generating the surround-view video sequence additionally based on output from the additional image generator.

32. The system of claim 31, wherein the moving camera includes a pan/tilt camera.

33. A method for obtaining video of a moving fixation point within a scene, comprising:
capturing a first plurality of images of the fixation point with a plurality of non-moving image capturing devices positioned around the scene, wherein the scene is within a field of view of each image capturing device;
generating a viewing angle command and a zoom command for each image capturing device; and
generating a second plurality of images, wherein each image of the second plurality of images corresponds to an image that a virtual camera located at a position of each of the image capturing devices would capture based on the first plurality of images, the viewing angle command for each image capturing device, and the zoom parameter for each image capturing device.

34. The method of claim 33, further comprising outputting the second plurality of images in sequence according to the position of the image capturing devices around the scene.

35. The method of claim 33, further comprising:
generating a second viewing angle command and a second zoom command for each image capturing device; and
generating a third plurality of images, wherein each image of the third plurality of images corresponds to an image that a virtual camera located at a position of each of the image capturing devices would capture based on the first plurality of images, the second viewing angle command for each image capturing device, and the second zoom parameter for each image capturing device.

36. The method of claim 35, further comprising:
outputting the second plurality of images in sequence according to the position of the image capturing devices around the scene; and
outputting the third plurality of images in sequence according to the position of the image capturing devices around the scene.
